(19) United States
(12) Patent Application Publication
(10) Pub. No.: US 2022/0374857 A1
(43) Pub. Date: Nov. 24, 2022

(54) REGISTRATION APPARATUS, INFORMATION PROCESSING APPARATUS, AND METHOD

(71) Applicant: TOSHIBA TEC KABUSHIKI KAISHA, Tokyo (JP)

(72) Inventors: Fumio NAKATSUKASA, Yokohama (JP); Kenya HIRAMATSU, Tokyo (JP); Shiori HIDAKA, Fujisawa (JP)

(73) Assignee: TOSHIBA TEC KABUSHIKI KAISHA, Tokyo (JP)

(21) Appl. No.: 17/575,532

(22) Filed: Jan. 13, 2022

(30) Foreign Application Priority Data
May 20, 2021 (JP) 2021-085472

(51) Int. Cl. G06Q 20/20; A47F 9/04; G06Q 30/02

(52) U.S. Cl. CPC G06Q 20/208; A47F 9/045; A47F 9/046; G06Q 30/0238

(57) ABSTRACT

A registration apparatus includes a reader, an imaging device, and a processor. The reader is configured to read commodity identification information for identifying a commodity from a code symbol attached to the commodity and to read benefit information regarding a benefit of a commodity from a benefit symbol attached to the commodity. The imaging device is configured to image an imaging area including a readable area of the reader. The processor is configured to extract identification data corresponding to the commodity identification information, acquire image data obtained by the imaging device, determine whether a commodity in the acquired image data is the same as the commodity that is identified by the commodity identification information, and register transaction information regarding transaction of the commodity identified by the commodity identification information.

### CROSS-REFERENCE TO RELATED APPLICATION

This application is based upon and claims the benefit of priority from Japanese Patent Application No. 2021-085472, filed on May 20, 2021, the entire contents of which are incorporated herein by reference.

### FIELD

Embodiments described herein relate generally to a registration apparatus, an information processing apparatus, and a method.

### BACKGROUND

In a store such as a supermarket, for example, providing commodities such as fresh food, price reduction sale where a commodity is sold at a price obtained by subtracting a given price from the list price or discount sale where a commodity is sold at a price obtained by discounting the list price at a given rate is performed. In the following description, price reduction and discount will be collectively referred to as “discount”, and price reduction sale and discount sale will be collectively referred to as “discount sale”.

If the discount sale is performed, a clerk in the store attaches a discount seal on which a discount price or the like is printed to the commodity such that a customer can recognize discount information. A registration apparatus that registers commodity information to execute a checkout process reads a commodity code for identifying a commodity from a barcode attached to the commodity. The registration apparatus reads not only character information such as a printed discount price but also discount information from a barcode representing discount information that is printed together with the character information. The registration apparatus registers transaction information (hereinafter, also referred to as commodity registration) including commodity information (for example, a commodity name and a price) and discount information acquired based on the read commodity code.

On the other hand, recently, a registration apparatus that is operated by a customer who purchases commodities is put into practice in a store due to labor shortage. As the registration apparatus, for example, an apparatus called a self-checkout point of sales (POS) terminal or a cart POS terminal is known.

The self-checkout POS terminal is provided in a checkout location of a store such that a customer registers commodities brought by the customer and executes an operation relating to payment of the commodities by themselves. Regarding the cart POS terminal, a scanner and an information terminal are provided in a shopping cart such that a customer registers commodities using the scanner in a sale counter. Transaction information regarding transaction of the registered commodities is transmitted to a checkout apparatus that executes the checkout process if the customer pays the price. An apparatus that registers commodities using a mobile terminal such as a smartphone carried by a customer instead of the tablet terminal and the scanner is known.

In the registration apparatus, the commodity registration is entrusted to a customer. Therefore, a fraud by the customer relating to the discount sale may occur. For example, there may be a case where a commodity code of a commodity that is not for discount is read with a scanner and a discount seal attached to another commodity is read to register the commodity that is not for discount. In order to prevent such fraud, a technique of checking previous transaction history of a commodity to prevent fraud if the commodity is registered by a registration apparatus is disclosed.

However, there may be a case in which a discount seal that is attached to a commodity to be purchased by a customer is not checked. Therefore, it cannot be said that the effect of preventing fraud is sufficient.

### DESCRIPTION OF THE DRAWINGS

FIG. 1 is a diagram illustrating the summary of a checkout system including a registration apparatus according to an exemplary embodiment;

FIG. 2 is a diagram illustrating the external appearance of a shopping cart to which the registration apparatus is attached;

FIG. 3 is a diagram illustrating a commodity to which a discount seal used in the exemplary embodiment of FIG. 1 is bonded;

FIG. 4 is a block diagram illustrating a hardware configuration of a registration apparatus including an information processing apparatus;

FIG. 5 is a diagram illustrating a data configuration of a commodity master stored in a memory unit in the information processing apparatus;

FIG. 6 is a block diagram illustrating a functional configuration of a control unit in the information processing apparatus;

FIG. 7 is a flowchart illustrating the flow of a registration process by the control unit in the information processing apparatus;

FIG. 8 is a block diagram illustrating a functional configuration of a control unit in an information processing apparatus according to an exemplary embodiment;

FIG. 9 is a diagram illustrating an example of image data obtained by an imaging unit if commodity identification information is read by a reading unit;

FIG. 10 is a diagram illustrating an example of image data obtained by the imaging unit if benefit information is read by the reading unit;

FIG. 11 is a flowchart illustrating the flow of a registration process by a control unit in an information processing apparatus; and

FIG. 12 is a flowchart illustrating the flow of a registration process by a control unit in an information processing apparatus according to an exemplary embodiment.

### DETAILED DESCRIPTION

Embodiments provide a registration apparatus that can improve an effect of preventing fraud relating to discount sale, an information processing apparatus, and a method is provided herein.

In general, according to at least one embodiment, a registration apparatus includes: a reader configured to read commodity information for identifying a commodity from a code symbol attached to the commodity and to read benefit information regarding a benefit of a commodity from a benefit symbol attached to the commodity; an imaging device configured to image an imaging area including a readable area of the reader; and a processor configured to extract identification data corresponding to the commodity identification information read by the reader from a memory configured to store the commodity identification information where the commodity identification information and the identification data are correlated with each other, the identification data relating to a commodity image, acquire image data obtained by the imaging device in response to reading the benefit information by the reader, determine, based on the extracted identification data, whether a commodity in the acquired image data is the same as the commodity that is identified by the commodity identification information read by the reader, and register, in response to determining that the commodities are the same, transaction information regarding transaction of the commodity identified by the commodity identification information based on the commodity identification information and the benefit information read by the reader.

Hereinafter, a registration apparatus, an information processing apparatus, and a method according to exemplary embodiments will be described with reference to the drawings. The exemplary embodiments are not limited to the embodiments described below. For example, in the exemplary embodiments described below, an example where the registration apparatus is configured with a tablet terminal and a scanner will be described. The registration apparatus maybe one information apparatus having a function of reading commodity information or the like, a function of registering transaction information, and an imaging function. For example, the registration apparatus may be configured with a smartphone in which an application program for commodity registration is installed.

### First Embodiment

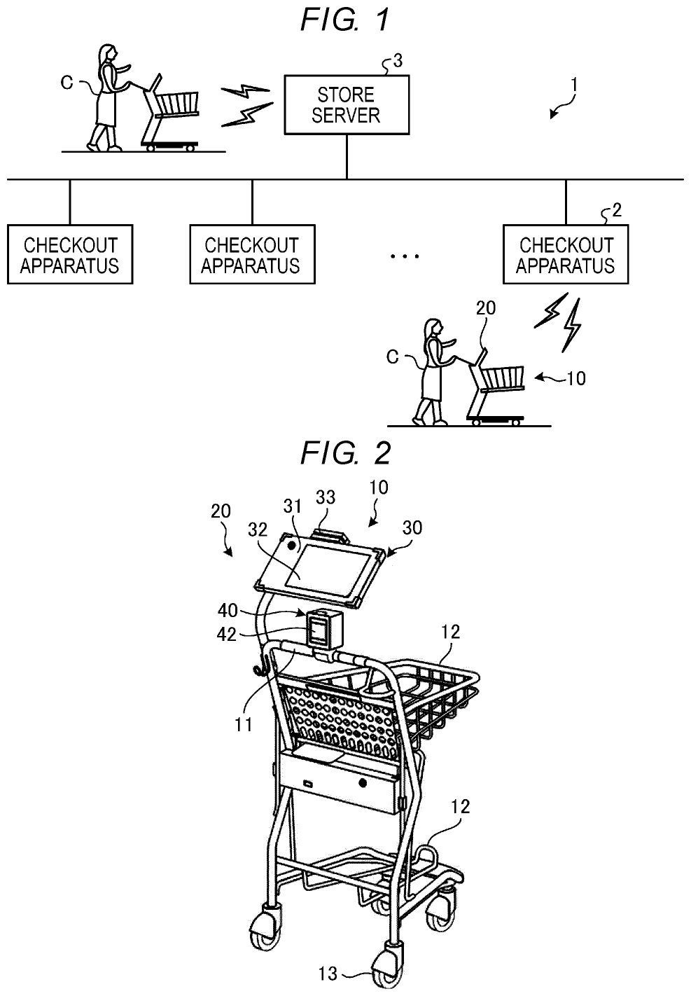

Hereinafter, a registration apparatus, an information processing apparatus, and a method according to an exemplary first embodiment will be described with reference to the drawings. FIG. 1 is a diagram illustrating the summary of a checkout system including the registration apparatus. A checkout system 1 according to the embodiment is applied to, for example, a supermarket where fresh food or the like that is a commodity for discount sale is sold. The checkout system 1 includes a plurality of shopping carts 10 to which a plurality of checkout apparatuses 2, a store server 3, and a registration apparatus 20 are attached. The checkout apparatuses 2 and the store server 3 are communicatively connected to each other via a network such as a local area network (LAN). Each of the registration apparatus 20 is communicatively connected to the checkout apparatus 2 and the store server 3 via a wireless LAN or the like.

The checkout apparatus 2 is a so-called self-service checkout apparatus where, for example, a customer C executes a checkout operation. The checkout apparatus 2 executes a checkout process relating to cash settlement or cashless settlement such as credit card settlement based on transaction information received from the registration apparatus 20. The checkout process is a process for paying the price of a commodity to be purchased by the customer C. The checkout apparatus 2 may be a POS terminal that is operated by a clerk.

The store server 3 receives settlement information regarding commodity information of a paid commodity, a settlement method, or the like in the checkout process from each of the checkout apparatuses 2. The store server 3 receives sales information representing a sales amount in a predetermined period of time (for example, one day) from the checkout apparatus 2. The store server 3 intensively manages the commodity information, the settlement information, the sales information, and the like received from each of the checkout apparatuses 2 and executes sales management or the like in one store. The store server 3 stores a commodity master where a commodity code and commodity information (for example, a commodity name, a price, or identification data) of a commodity handled at a store are correlated with each other and appropriately transmits the commodity master to the registration apparatus 20.

The shopping cart 10 is provided in a sale counter of a store and is used for transporting commodities to be purchased by the customer C. While pushing the shopping cart 10 to move in the sale counter, the customer C registers commodities to be purchased using the registration apparatus 20 and accommodates the registered commodities placed in the shopping cart 10 in, for example, a basket.

FIG. 2 is a diagram illustrating the external appearance of the shopping cart 10 to which the registration apparatus 20 is attached. The shopping cart 10 includes a handle 11, a basket placing unit 12 (e.g., basket, etc.) and casters 13, and the registration apparatus 20 is attached to the shopping cart 10. The handle 11 is held by the customer C to move the shopping cart 10. The basket placing unit 12 is configured with two upper and lower stages, in which a basket that accommodates commodities to be purchased by the customer C can be placed. The basket may be integrally provided in the shopping cart 10. The caster 13 is provided in each of four corners in a lower portion of the shopping cart 10. By individually rotating the casters 13, the shopping cart 10 can freely move in a store. The shopping cart 10 is a moving object including the registration apparatus 20.

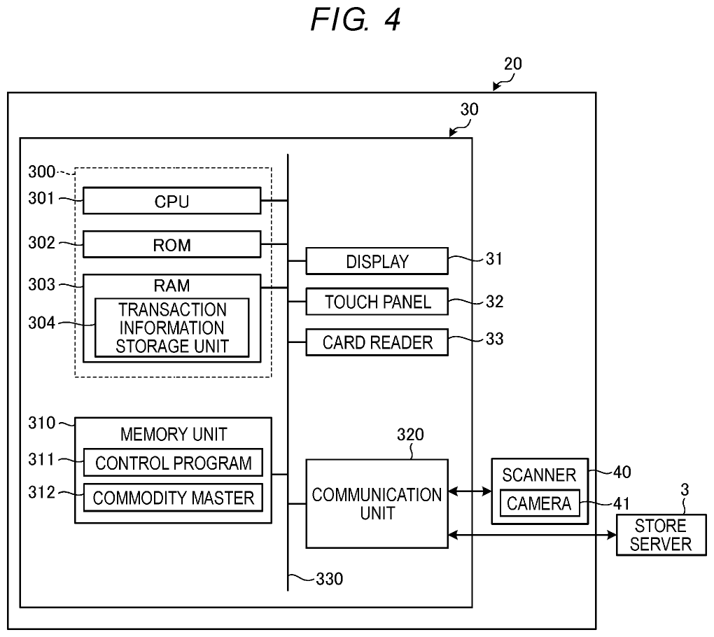

The registration apparatus 20 registers transaction information of a commodity and includes a tablet terminal 30 and a scanner 40 including a camera 41 (refer to FIG. 4). The transaction information is information required for paying the price of a commodity to be purchased by the customer C, and includes commodity information (for example, a commodity name or a price) and benefit information (for example, a discount amount). The discount information regarding discount such as a discount amount is an example of the benefit information. The benefit information is not limited to the discount information and may be information representing, for example, provision of a point that is specially added.

The tablet terminal 30 includes a display 31, a touch panel 32, and a card reader 33. The tablet terminal 30 is an example of the information processing apparatus.

The display 31 is configured with, for example, a liquid crystal panel and functions as a display unit that displays various information. The display 31 displays, for example, the commodity information of a registered commodity or an operator that is operated by the customer C as a user.

The touch panel 32 is provided on a surface of the display 31 such that information corresponding to a touched position is input to a control unit 300 (refer to FIG. 4) of the tablet terminal 30, and functions as an operation input unit that inputs information corresponding to an operation of the customer C as a user. The touch panel 32 inputs a checkout instruction for instructing the checkout apparatus 2 to transmit the transaction information to the control unit 300.

The card reader 33 reads a member code from a medium such as a membership card or a point card of the customer C. If the registration apparatus 20 has a settlement function, for example, the card reader 33 can also read credit card information from a credit card of the customer C. The card reader 33 may be a magnetic card reader that reads information from a magnetic card or may be an IC card reader that reads information from a card in which an IC chip is built.

The scanner 40 is provided in the handle 11 of the shopping cart 10. A reading window 42 is formed in the scanner 40. The camera 41 images an imaging area including a reading area where the scanner 40 can read the commodity code or the discount information using a method described below. For example, the camera 41 images a commodity held up to the reading window 42 and a barcode attached to the commodity.

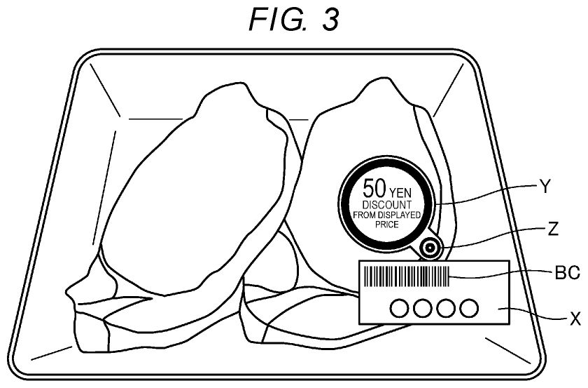

The scanner 40 reads commodity identification information for identifying a commodity from a code symbol attached to the commodity. For example, the scanner 40 reads a commodity code for identifying a commodity shown in FIG. 3 from a barcode BC that is printed on a commodity label X attached to the commodity. Specifically, the camera 41 reads information represented by the barcode BC based on an image obtained by imaging the barcode BC positioned in the readable area of the scanner 40. More specifically, if the customer C disposes the barcode BC attached to a commodity to be purchased in the readable area facing the reading window 42, the camera 41 obtains an image including the barcode BC. The scanner 40 extracts the barcode BC by pattern recognition or the like from a predetermined area of the image obtained by the camera 41, decodes the extracted barcode BC, and reads a commodity code represented by the barcode BC. The barcode BC is an example of the code symbol, and the commodity code is an example of the commodity identification information.

The scanner 40 reads benefit information regarding a benefit of a commodity from a benefit symbol attached to the commodity. For example, if the customer C disposes a discount seal Y attached to a commodity to be purchased in the readable area facing the reading window 42, the camera 41 obtains an image including the discount seal Y. The scanner 40 extracts the discount seal Y by pattern recognition or the like from a predetermined area of the image obtained by the camera 41, and reads character information printed on the discount seal Y through a character recognition process such as an optical character reader (OCR) or recognizes a discount amount or a discount rate represented by the discount seal through an image recognition process. The discount seal Y on which characters representing the content of discount are printed is an example of the benefit symbol.

As described above, the scanner 40 reads a commodity code (commodity identification information) for identifying a commodity from a barcode (code symbol) attached to the commodity, reads benefit information regarding a benefit of a commodity from the discount seal Y (benefit symbol) attached to the commodity, and is an example of the reading unit. The camera 41 is an example of the imaging unit.

Here, at least one example of a process of reading the benefit information regarding a benefit of a commodity will be described. First, the scanner 40 reads flag information representing that a label representing benefit information is attached to a commodity. Specifically, the scanner 40 reads the flag information by detecting a flag seal Z (refer to FIG. 3) from an image obtained if the barcode BC of the commodity label is read. The scanner 40 detects the flag seal Z by executing image processing of detecting a predetermined shape (in the exemplary embodiment, a double circle) the obtained image. The information representing the flag seal Z is an example of the flag information.

The flag seal Z is bonded close to the barcode BC representing the commodity code under the operation of a store. It is because if the customer C moves the barcode BC close to the reading window 42 to read the commodity code, the scanner 40 can recognize not only the barcode BC but also flag seal Z. As a result, the scanner 40 can cause the display 31 to execute a display prompting the customer C to read the discount seal Y, and can prevent the customer C from forgetting to read the discount information.

In the example shown in FIG. 3, the flag seal Z is provided to be integrated with the discount seal Y. However, the flag seal Z may be bonded separately from the discount seal Y. For example, if the barcode BC is bonded to a back surface of a commodity, the flag seal Z is bonded to the back surface of the commodity close to the barcode BC and the discount seal Y is bonded to a front surface of the commodity such that the customer C can easily recognize that the commodity is a discounted commodity.

If the flag information is read from the flag seal Z, the scanner 40 subsequently reads the discount information from the discount seal Y. After the camera 41 obtains an image including the discount seal Y, the scanner 40 detects the discount seal Y from a specific area of the obtained image and reads discount information represented by the character information in the discount seal. The scanner 40 outputs the image including the discount seal Y obtained by the camera 41 to the tablet terminal 30.

At least one of the processes of reading the information represented by the barcode BC from the image obtained by the camera 41 (hereinafter, also referred to as “barcode reading process”), reading the information represented by the flag seal Z from the image obtained by the camera 41 (hereinafter, also referred to as “flag seal reading process”), and reading the information represented by the discount seal Y from the image obtained by the camera 41 (hereinafter, also referred to as “discount seal reading process”) maybe executed by the control unit 300 of the tablet terminal 30. Here, the reading unit is configured to include the scanner 40 and the control unit 300.

In the following description, the scanner 40 reading the commodity code from the barcode BC will also be referred to as “reading the barcode BC”, the scanner 40 reading the flag information from the flag seal Z will also be referred to as “reading the flag seal Z”, and the scanner 40 reading the discount information from the discount seal Y will also be referred to as “reading the discount seal Y”.

FIG. 4 is a block diagram illustrating a hardware configuration of a block diagram of the registration apparatus 20. As described above, the registration apparatus 20 includes the tablet terminal 30 and the scanner 40. The tablet terminal 30 includes the control unit 300, a memory unit 310, the display 31, the touch panel 32, the card reader 33, and a communication unit 320. The control unit 300, the memory unit 310, the display 31, the touch panel 32, the card reader 33, and the communication unit 320 are connected to each other via a bus 330 or the like.

The control unit 300 is configured with a computer including a central processing unit (CPU) 301, a read only memory (ROM) 302, and a random access memory (RAM) 303. The CPU 301, the ROM 302, and the RAM 303 are connected to each other via the bus 330.

The CPU 301 controls an overall operation of the tablet terminal 30. The ROM 302 stores various programs such as a program used for driving the CPU 301 or various data. The RAM 303 includes a transaction information storage unit 304. The transaction information storage unit 304 is an area where the transaction information is stored for each transaction based on the commodity code or the discount information read by the scanner 40. The RAM 303 is used as a work area of the CPU 301, and loads various programs or various data stored in the ROM 302 or the memory unit 310. The control unit 300 executes various control processes of the tablet terminal 30 by the CPU 301 operating according to a control program that is stored in the ROM 302 or the memory unit 310 and is loaded to the RAM 303.

The memory unit 310 is configured with a storage medium such as a hard disk drive (HDD) or a flash memory and maintains the storage content even if power supply is interrupted. The memory unit 310 includes a control program 311 and a commodity master 312.

The control program 311 is, for example, a program for implementing a function of registering a commodity based on the commodity code, the discount information, or the like read by the scanner 40, a function of determining whether the discount information read by the scanner 40 is appropriate based on the image data obtained by the camera 41, and the like.

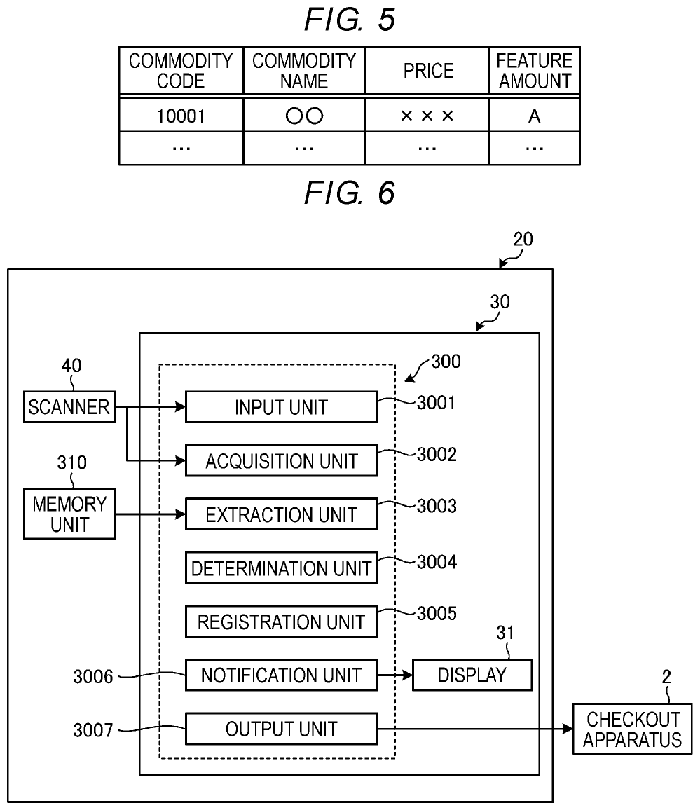

The commodity master 312 is a master file that stores information of commodities handled at a store, and is received from the store server 3 via the communication unit 320. Commodities handled at the shop change every day. Therefore, the commodity master 312 is appropriately updated based on information from the store server 3. FIG. 5 is a diagram illustrating a data configuration of the commodity master 312. In the commodity master 312, various information representing a commodity code, a commodity name, a price, and feature data are correlated with each other.

In the field of the commodity code, a commodity code for identifying a commodity is registered. In the field of the commodity name, information representing a name of the commodity is registered. In the field of the price, information representing a unit price of the commodity is registered. The unit price of the commodity may be a pre-tax price or a price including tax. Information registered in the field of the feature data is information representing feature data for generic object recognition to specify the commodity from the image data (e.g., frame image, etc.). The information representing the feature data is data for comparison representing feature data of the external appearance of a commodity image, for example, data regarding the color of the commodity, the external shape thereof, and the unevenness shape of the surface thereof. The information stored in the field of the feature data is an example of the identification data regarding the commodity image.

Referring back to FIG. 4, the description will be continued. The configurations and functions of the display 31, the touch panel 32, and the card reader 33 are as described above. The communication unit 320 (e.g., a communicator, communication device, etc.) is an interface for communication with the scanner 40 and the store server 3. The control unit 300 is connected to each of the scanner 40 and the store server 3 via the communication unit 320 such that information (data) can be transmitted to and received from the each of the apparatuses.

Next, a functional configuration of the control unit 300 of the tablet terminal 30 will be described. FIG. 6 is a block diagram illustrating the functional configuration of the control unit 300 of the tablet terminal 30. By the CPU 301 operating according to the control program stored in the ROM 302 or the memory unit 310, the control unit 300 functions as an input unit 3001, an acquisition unit 3002, an extraction unit 3003, a determination unit 3004, a registration unit 3005, a notification unit 3006, and an output unit 3007. Each of the functions may be configured with hardware such as a dedicated circuit.

The commodity identification information for identifying a commodity and the benefit information regarding a benefit of the commodity are input to the input unit 3001 from the scanner 40 that reads the commodity identification information and the benefit information. Specifically, the commodity code read from the barcode BC attached to the commodity by the scanner 40 is input to the input unit 3001. The discount information read from the discount seal Y attached to the commodity by the scanner 40 is input to the input unit 3001. The flag information read from the flag seal Z by the scanner 40 or various information regarding the operation of the customer C through the touch panel 32 are input.

The acquisition unit 3002 acquires the image data obtained by the camera 41 if the benefit information is read by the scanner 40. Specifically, the acquisition unit 3002 acquires the image data obtained if the camera 41 images the commodity in order for the scanner 40 to read the discount information of the discount seal Y. The image data acquired by the acquisition unit 3002 is a commodity image of the commodity including the discount seal Y.

The extraction unit 3003 extracts identification data corresponding to the commodity identification information read by the scanner 40 from the memory unit 310 where the commodity identification information and the identification data are correlated with each other, the identification data relating to the commodity image. Specifically, the extraction unit 3003 reads the feature data corresponding to the commodity code input to the input unit 3001 from the memory unit 310 that stores the commodity master 312 where the commodity code and information for comparison representing the feature data of the external appearance of the commodity (hereinafter, simply referred to as “feature data”) are correlated with each other. The extraction unit 3003 outputs the read feature data to the determination unit 3004. The memory unit 310 that stores the commodity master 312 may be provided in an external apparatus such as the store server 3.

The determination unit 3004 determines, based on the identification data extracted by the extraction unit 3003, whether a commodity in the image data acquired by the acquisition unit 3002 is the same as a commodity that is identified by the commodity identification information read by the scanner 40. Specifically, the determination unit 3004 extracts the feature data of the commodity in the image data from the image data acquired by the acquisition unit 3002, compares the feature data of the commodity to the feature data extracted from the memory unit 310 by the extraction unit 3003, and calculates a similarity therebetween. The determination unit 3004 determines whether the commodity in the image data acquired by the acquisition unit 3002 is the same as the commodity identified by the commodity code input to the input unit 3001 based on the calculated similarity. In other words, the determination unit 3004 determines whether the commodity of which the discount seal Y is read by the scanner 40 is the same as the commodity from which the scanner 40 reads the barcode BC. For example, if the calculated similarity is a predetermined set value or more, the determination unit 3004 determines that both of the commodities are the same. The extraction of the feature data of the commodity from the image data acquired by the acquisition unit 3002 is implemented using a well-known image recognition technique such as generic object recognition.

If the determination unit 3004 determines that the commodities are the same, the registration unit 3005 registers transaction information regarding transaction of the commodity identified by the commodity identification information based on the commodity identification information and the benefit information read by the scanner 40. Specifically, if the determination unit 3004 determines that the commodity in the image data acquired by the acquisition unit 3002 is the same as the commodity identified by the commodity code input to the input unit 3001, the registration unit 3005 stores the transaction information where the commodity information and the discount information are correlated with each other in the transaction information storage unit 304. If the determination unit 3004 determines that the commodities are not the same, the registration unit 3005 determines that a discount seal different from the discount seal attached to the commodity of which the commodity code is read by the scanner 40 is read, and does not store the transaction information in the transaction information storage unit 304.

If the scanner 40 does not read the flag information, the registration unit 3005 determines that the commodity identified by the commodity identification information has no benefit, and stores the transaction information in the transaction information storage unit 304. Specifically, if the flag information is not input to the input unit 3001 together with the commodity code, the registration unit 3005 determines that the commodity identified by the commodity code is not a commodity for discount, and stores the commodity information in the transaction information storage unit 304 as the transaction information. The commodity information such as a commodity name or a price is acquired from the commodity master 312 based on the commodity code input to the input unit 3001. If the commodity code is input to the input unit 3001, the registration unit 3005 may output an inquiry about the commodity information based on the commodity code to the store server 3 where the commodity master 312 is stored to acquire the commodity information from the store server 3. Here, the memory unit 310 may not store the commodity master 312. The registration unit 3005 storing (registering) the transaction information in the transaction information storage unit 304 will be referred to as “commodity registration”.

If the benefit information is not read by the scanner 40 even after a predetermined period of time is elapsed from the reading of the flag information by the scanner 40, the registration unit 3005 does not register the transaction information of the commodity identified by the commodity identification information. Specifically, if the discount information is not input to the input unit 3001 even after a predetermined period of time is elapsed from the input of the flag information to the input unit 3001, the registration unit 3005 determines that there is a possibility that a discount seal different from the discount seal attached to the commodity identified by the input commodity code is read, and does not execute the commodity registration.

If the determination unit 3004 determines that the commodity in the image data acquired by the acquisition unit 3002 is not the same as the commodity identified by the commodity code input to the input unit 3001, the notification unit 3006 notifies an error message to the customer C. For example, the notification unit 3006 causes the display 31 to display a message prompting the customer C to execute the commodity registration again. The notification by the notification unit 3006 may be executed using a sound. Even when the discount information is not input to the input unit 3001 even after a predetermined period of time is elapsed although the flag information is input to the input unit 3001, the notification unit 3006 also executes notification prompting the customer C to execute the commodity registration again.

If a checkout instruction is input from the touch panel 32 to the input unit 3001, the output unit 3007 outputs the transaction information of each transaction stored in the transaction information storage unit 304 to the checkout apparatus 2. The checkout apparatus 2 that receives the transaction information can execute the checkout process.

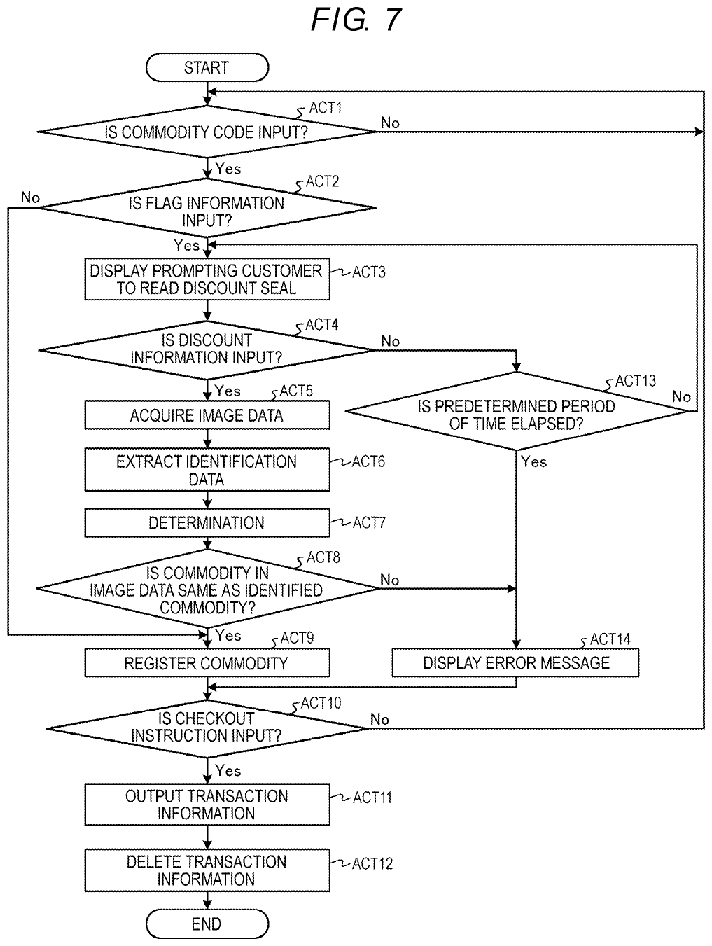

An operation of the registration apparatus 20 based on the configuration will be described. FIG. 7 is a flowchart illustrating the flow of a registration process by the control unit 300 of the tablet terminal 30.

First, the control unit 300 determines whether the commodity code is input to the input unit 3001 (ACT 1). If the commodity code is not input to the input unit 3001 (No in ACT 1), the control unit 300 returns to the process of ACT 1 and waits. In other words, the control unit 300 determines whether the scanner 40 reads the commodity code from the barcode BC attached to the commodity.

If the commodity code is input to the input unit 3001 (Yes in ACT 1), the control unit 300 determines whether the flag information is input to the input unit 3001 (ACT 2). In other words, the control unit 300 determines whether the scanner 40 reads the flag information from the flag seal Z attached to the commodity.

If the flag information is input to the input unit 3001 (Yes in ACT 2), the control unit 300 outputs an instruction signal for display prompting the customer C to read the discount seal Y to the display 31 (ACT 3). The display 31 to which the instruction signal is input executes a display prompting the customer C to read the discount seal Y. Next, the control unit 300 determines whether the discount information is input to the input unit 3001 (ACT 4). In other words, the control unit 300 determines whether the scanner 40 reads the discount information from the discount seal Y attached to the commodity.

If the discount information is input to the input unit 3001 (Yes in ACT 4), the acquisition unit 3002 acquires the image data if the discount seal is read, that is, the image data obtained if the camera 41 images the commodity in order for the scanner 40 to read the discount information of the discount seal Y (ACT 5). Next, the extraction unit 3003 extracts the feature data that is the identification data corresponding to the commodity code input to the input unit 3001 with reference to the commodity master 312 (ACT 6).

Next, the determination unit 3004 compares the feature data of the commodity image in the image data acquired by the acquisition unit 3002 to the feature data extracted from the commodity master 312 by the extraction unit 3003 to determine whether the commodity in the image data acquired by the acquisition unit 3002 is the same as the commodity identified by the commodity code input to the input unit 3001 (ACT 7). The control unit 300 causes the determination unit 3004 to determine whether the commodity in the image data is the same as the commodity identified by the commodity code input to the input unit 3001 (ACT 8).

If the determination unit 3004 determines that the commodities are the same (Yes in ACT 8) , the registration unit 3005 executes the commodity registration (ACT 9). That is, the registration unit 3005 stores, in the transaction information storage unit 304, the transaction information where the commodity information acquired from the commodity master 312 based on the commodity code input to the input unit 3001 and the discount information input to the input unit 3001 are correlated with each other.

Next, the control unit 300 determines whether the checkout instruction is input to the input unit 3001 (ACT 10). If the checkout instruction is not input (No in ACT 10), the control unit 300 returns to the process of ACT 1 and waits until the next commodity code is input. If the checkout instruction is input (Yes in ACT 10), the output unit 3007 outputs the transaction information of each transaction stored in the transaction information storage unit 304 to the checkout apparatus 2 (ACT 11). After the output unit 3007 outputs the transaction information, the control unit 300 deletes the transaction information of each transaction stored in the transaction information storage unit 304 (ACT 12), and ends the registration process.

If the flag information is not input in the process of ACT 2 (No in ACT 2), the control unit 300 skips the process of ACT 3 to ACT 8 and proceeds to the process of ACT 9. If the flag information is not input, the registration unit 3005 determines that the commodity of which the commodity code is input is not a commodity for discount and executes the commodity registration. Here, the registration unit 3005 registers the commodity information acquired from the commodity master 312 based on the input commodity code in a transaction information storage unit 305 as the transaction information. That is, the transaction information does not include the discount information.

If the discount information is not input to the input unit 3001 in the process of ACT 4 (No in ACT 4), the control unit 300 determines whether a predetermined period of time is elapsed from the input of the commodity code to the input unit 3001 (ACT 13). If the predetermined period of time is not elapsed (No in ACT 13), the control unit 300 returns to the process of ACT 3. If the predetermined period of time is elapsed (Yes in ACT 13) , the notification unit 3006 determines that the customer C stores the commodity in the basket without reading the discount information and causes the display 31 to display an error message (ACT 14). The displayed error message is a message prompting the customer C to execute the commodity registration again, for example, “The discount information cannot be read. Please execute the commodity registration again”. Next, the control unit 300 proceeds to the process of ACT 10. If the determination unit 3004 determines that the commodities are the same in ACT 8 (No in ACT 8), the control unit 300 proceeds to the process of ACT 14. Here, there is a possibility that the input discount information is based on fraud. Therefore, the notification unit 3006 displays the error message to prompt the customer C to execute the commodity registration again.

The checkout apparatus 2 that receives the transaction information of each transaction from the tablet terminal 30 in the registration process executes the checkout process based on the transaction information.

In the first embodiment, if the registration apparatus 20 determines that the commodity of which the commodity code is read by the scanner 40 is the same as the commodity of which the discount information is read, the registration apparatus 20 determines that the discount information is valid and executes the commodity registration. If the registration apparatus 20 determines that the commodity of which the commodity code is read by the scanner 40 is not the same as the commodity of which the discount information is read, the registration apparatus 20 determines that the discount information is invalid and prompts the customer C to execute the commodity registration again. As a result, even in the registration apparatus where the commodity registration is executed by the customer C, fraud by the customer C relating to the discount sale can be prevented.

In the first embodiment, even regarding a commodity where the discount seal Y is bonded to a position distant from the commodity label X including the barcode BC, whether the commodity of which the barcode BC is read is the same as the commodity of which the discount seal Y is read can be determined. That is, the position where the discount seal Y is bonded is not limited. Therefore, even if the barcode BC is attached to a back surface of a commodity, the discount seal Y can be bonded to a front surface of the commodity such that the customer C can easily recognize the discount seal Y.

### Second Embodiment

Next, a second exemplary embodiment will be described. The second embodiment is different from the first embodiment in that first image data obtained if the barcode BC is read by the scanner 40 is compared to second image data obtained if the discount seal Y is read by the scanner 40 to determine whether the commodity of which the commodity code is read by the scanner 40 is the same as the commodity of which the discount information is read. Hereinafter, some of the same configurations and functions as those of the first embodiment will not repeated.

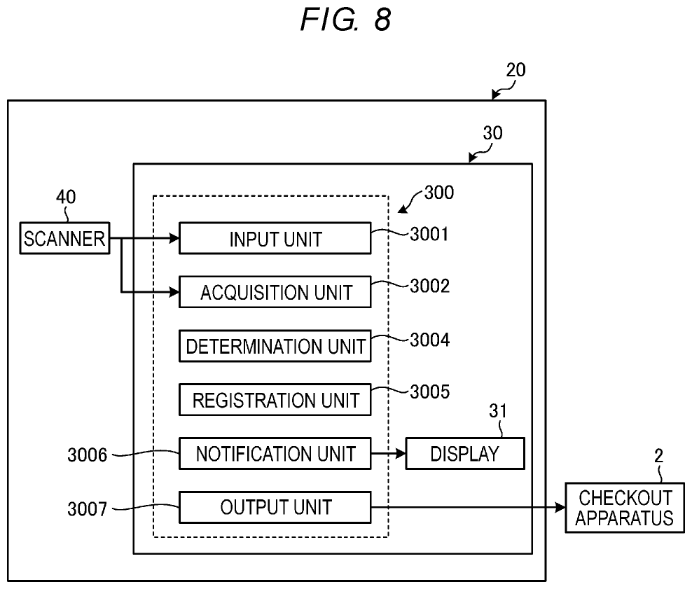

The hardware configuration of the checkout system 1 including the registration apparatus 20 is the same as that of the first embodiment. Therefore, first, the functional configuration of the control unit 300 of the tablet terminal 30 will be described. FIG. 8 is a block diagram illustrating the functional configuration of the control unit 300 of the tablet terminal 30. By the CPU 301 operating according to the control program stored in the ROM 302 or the memory unit 310, the control unit 300 functions as the input unit 3001, the acquisition unit 3002, the determination unit 3004, the registration unit 3005, the notification unit 3006, and an output unit 3007. Each of the functions may be configured with hardware such as a dedicated circuit.

The acquisition unit 3002 acquires the first image data obtained by the camera 41 if the commodity identification information is read by the scanner 40, and acquires the second image data obtained by the camera 41 if the benefit information is read by the scanner 40. Specifically, the acquisition unit 3002 acquires the first image data that is a frame image including the commodity to which the barcode BC is attached obtained by the camera 41 if the barcode BC is read by the scanner 40. The acquisition unit 3002 acquires the second image data that is a frame image including the commodity to which the discount seal Y is attached obtained by the camera 41 if the discount seal Y is read by the scanner 40. The discount seal Y bonded to the commodity is bonded close to the barcode BC.

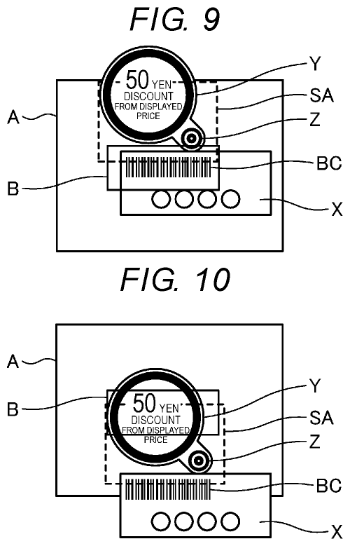

FIG. 9 is a diagram illustrating at least one example of the first image data, and FIG. 10 is a diagram illustrating at least one example of the second image data. FIGS. 9 and 10 illustrate a relationship between an imaging area of the camera 41 and a reading area. In FIGS. 9 and 10, the outer frame represents an imaging area A that is imaged by the camera 41 in one frame. In a center portion of the imaging area A, a reading area B where the commodity code or the discount information can be read is set. The imaging area A is an image area obtained by the camera 41 imaging an imaging area facing the reading window 42 of the scanner 40. The reading area B is an image area obtained by imaging the reading area facing the reading window 42.

The scanner 40 can read the information of the barcode BC and the discount seal Y in the reading area B, and is set to not read the information of the barcode BC and the discount seal Y in the imaging area A outside the reading area B. The scanner 40 can read the information of the flag seal Z in the imaging area A. In other words, the commodity code represented by the barcode BC and the discount information represented by the discount seal Y can be read only in the reading area B, and the flag information represented by the flag seal Z can be read in the imaging area A.

Referring back to FIG. 8, the functional configuration of the control unit 300 of the tablet terminal 30 will be described. The determination unit 3004 determines whether a commodity in the first image data is the same as a commodity in the second image data. For example, if an image area that is the same as an image area including a code symbol and a benefit symbol in the first image data is included in the second image data, the determination unit 3004 determines that the commodity in the first image data is the same as the commodity in the second image data.

More specifically, using an image processing technique, the determination unit 3004 determines whether a common image area including the barcode BC and the discount seal Y is present in the first image data and the second image data. As illustrated in FIGS. 9 and 10, if a common image area SA including the barcode BC and the discount seal Y is present in the first image data and the second image data, the determination unit 3004 determines that the commodity in the first image data is the same as the commodity in the second image data. The commodity label X or the discount seal Y including the barcode BC is manually bonded. Therefore, it is considered that a position relationship between the barcode BC and the discount seal Y varies depending on individual commodities. Therefore, if a common image including the barcode BC and the discount seal Y is present in the two images, the determination unit 3004 determines that the position relationships between the barcode BC and the discount seal Y in the two images are the same, and determines that the commodities shown in the two images are the same. The determination unit 3004 may determine whether the commodity in the first image data is the same as the commodity in the second image data by comparing the commodity image in the first image data to the commodity image in the second image data without considering the position relationship between the barcode BC and the discount seal Y. For example, the determination unit 3004 may determine that the commodities are the same if a part of the imaging area A (a sufficient range for determining that the commodities are the same) obtained by positioning the barcode BC in the reading area B to read the commodity code is positioned in the imaging area A obtained by positioning the discount seal Y in the reading area B to read the discount information.

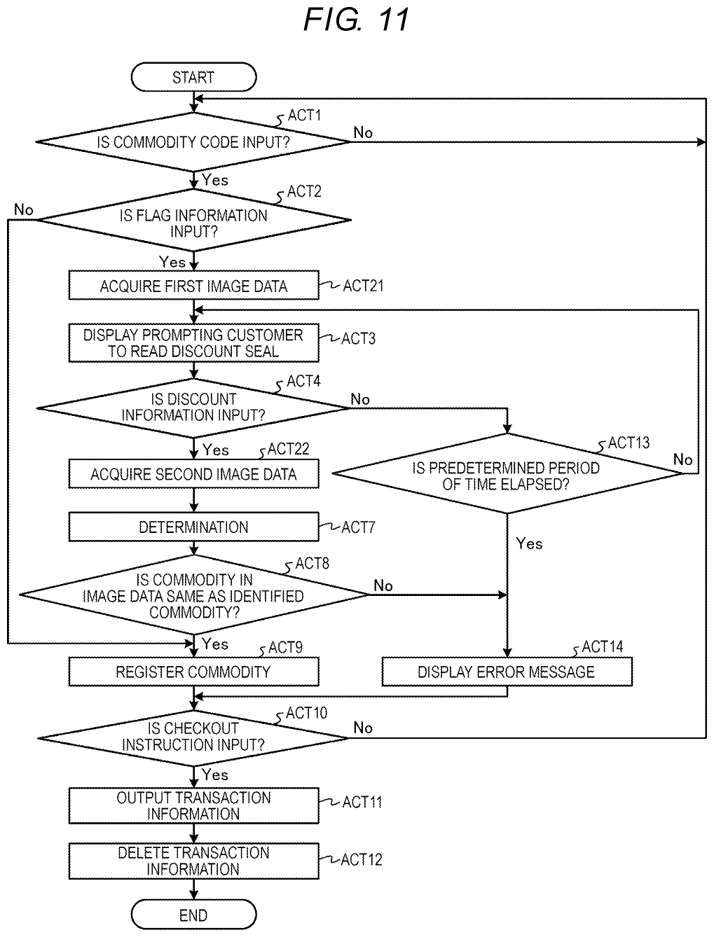

At least one example of an operation of the registration apparatus 20 based on the configuration will be described. FIG. 11 is a flowchart illustrating the flow of a registration process by the control unit 300 of the tablet terminal 30. The same processes as those of the first embodiment are represented by the same reference numerals, and the description thereof will not be repeated.

First, the control unit 300 determines whether the commodity code is input to the input unit 3001 (ACT 1). If the commodity code is not input to the input unit 3001 (No in ACT 1), the control unit 300 returns to the process of ACT 1 and waits. If the commodity code is input to the input unit 3001 (Yes in ACT 1), the control unit 300 determines whether the flag information is input to the input unit 3001 (ACT 2).

If the flag information is input to the input unit 3001 (Yes in ACT 2), the acquisition unit 3002 acquires the first image data, that is, the image data obtained if the camera 41 images the commodity in order for the scanner 40 to read the commodity code (ACT 21). Next, the control unit 300 outputs an instruction signal for display prompting the customer C to read the discount seal Y to the display 31 (ACT 3).

Next, the control unit 300 determines whether the discount information is input to the input unit 3001 (ACT 4). If the discount information is input to the input unit 3001 (Yes in ACT 4), the acquisition unit 3002 acquires the second image data, that is, the image data obtained if the camera 41 images the commodity in order for the scanner 40 to read the discount information of the discount seal Y (ACT 22).

Next, the determination unit 3004 determines whether the commodity in the first image data is the same as the commodity in the second image data by determining whether the common image area including the barcode BC and the discount seal Y is present in the first image data and the second image data acquired by the acquisition unit 3002 (ACT 7). The control unit 300 causes the determination unit 3004 to determine whether the commodity in the first image data is the same as the commodity in the second image data (ACT 8).

If the determination unit 3004 determines that the commodities are the same (Yes in ACT 8) , the registration unit 3005 executes the commodity registration (ACT 9). Next, the control unit 300 determines whether the checkout instruction is input to the input unit 3001 (ACT 10). If the checkout instruction is not input (No in ACT 10), the control unit 300 returns to the process of ACT 1 and waits until the next commodity code is input. If the checkout instruction is input (Yes in ACT 10), the output unit 3007 outputs the transaction information stored in the transaction information storage unit 304 to the checkout apparatus 2 (ACT 11). After the output unit 3007 outputs the transaction information, the control unit 300 deletes the transaction information of each transaction stored in the transaction information storage unit 304 (ACT 12), and ends the registration process.

If the flag information is not input in the process of ACT 2 (No in ACT 2), the control unit 300 proceeds to the process of ACT 9. If the discount information is not input to the input unit 3001 in the process of ACT 4 (No in ACT 4), the control unit 300 determines whether a predetermined period of time is elapsed from the input of the commodity code to the input unit 3001 (ACT 13). If the predetermined period of time is not elapsed (No in ACT 13), the control unit 300 returns to the process of ACT 3. If the predetermined period of time is elapsed (Yes in ACT 13) , the notification unit 3006 causes the display 31 to display an error message (ACT 14). The displayed error message is a message prompting the customer C to execute the commodity registration again, for example, “The discount information cannot be read. Please execute the commodity registration again”. Next, the control unit 300 proceeds to the process of ACT 10. If the determination unit 3004 determines that the commodities are not the same in ACT 8 (No in ACT 8), the control unit 300 proceeds to the process of ACT 14.

In the second embodiment, as in the first embodiment, even in the registration apparatus where the commodity registration is executed by the customer C, fraud by the customer C relating to the discount sale can be prevented.

In the second embodiment, whether the commodity of which the commodity code is read is the same as the commodity of which the discount information is read is determined depending on whether the common image area SA including the barcode BC and the discount seal Y is present in the first image data and the second image data acquired by the acquisition unit 3002. Therefore, the determination can be executed on a per item basis. Therefore, fraud by the customer C can be prevented. For example, even if a commodity code of a commodity to which the discount seal Y is not bonded is read and subsequently the discount seal Y bonded to the same commodity (commodity having the same commodity code) as the corresponding commodity is read, the registration apparatus 20 does not register the discount information. Therefore, fraud can be further prevented.

### Third Embodiment

Next, a third exemplary embodiment will be described. In the third embodiment, whether the commodity of which the commodity code is read by the scanner 40 is the same as the commodity of which the discount information is read is determined using both of the determination of the first embodiment and the determination of the second embodiment. Hereinafter, some of the same configurations and functions as those of the first embodiment and/or the second embodiment will not be repeated.

The hardware configuration of the checkout system 1 including the registration apparatus 20 is the same as that of the first embodiment and the second embodiment. The functions of the control unit 300 of the tablet terminal 30 include the functions of the first embodiment and the functions of the second embodiment.

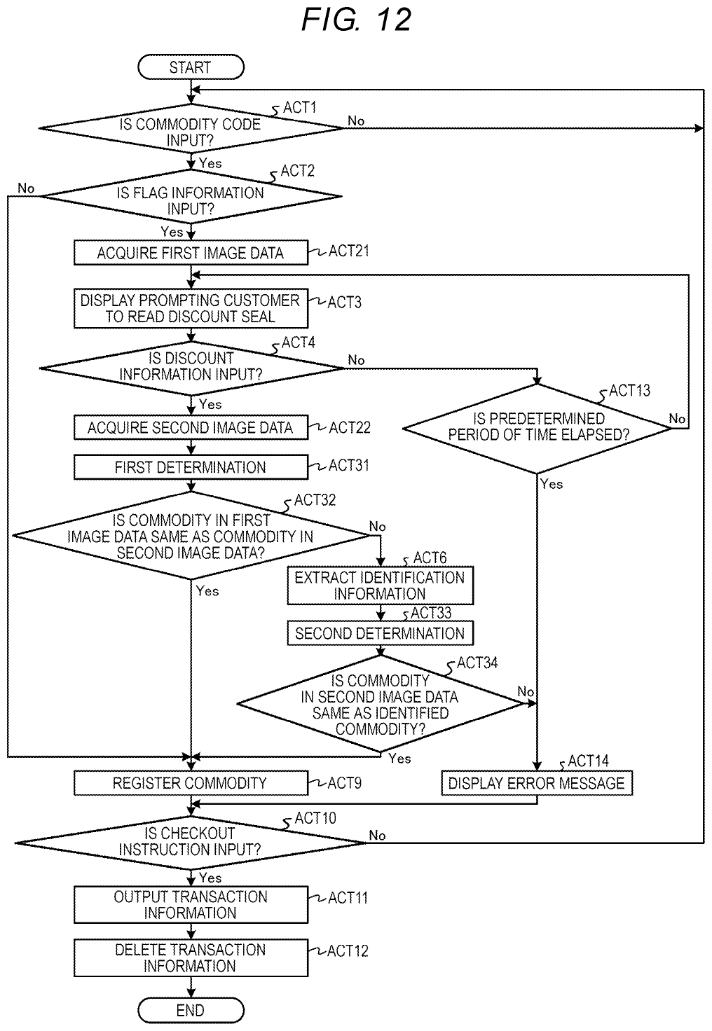

The operation of the registration apparatus 20 will be described. FIG. 12 is a flowchart illustrating the flow of a registration process by the control unit 300 of the tablet terminal 30. The same processes as those of the first embodiment and/or the second embodiment are represented by the same reference numerals, and the description thereof will not be repeated.

First, the control unit 300 determines whether the commodity code is input to the input unit 3001 (ACT 1). If the commodity code is not input to the input unit 3001 (No in ACT 1), the control unit 300 returns to the process of ACT 1 and waits. If the commodity code is input to the input unit 3001 (Yes in ACT 1), the control unit 300 determines whether the flag information is input to the input unit 3001 (ACT 2).

If the flag information is input to the input unit 3001 (Yes in ACT 2), the acquisition unit 3002 acquires the first image data, that is, the image data obtained if the camera 41 images the commodity in order for the scanner 40 to read the commodity code (ACT 21). Next, the control unit 300 outputs an instruction signal for display prompting the customer C to read the discount seal Y to the display 31 (ACT 3).

Next, the control unit 300 determines whether the discount information is input to the input unit 3001 (ACT 4). If the discount information is input to the input unit 3001 (Yes in ACT 4), the acquisition unit 3002 acquires the second image data, that is, the image data obtained if the camera 41 images the commodity in order for the scanner 40 to read the discount information of the discount seal Y (ACT 22).

Next, the determination unit 3004 executes a first determination (ACT 31). In the first determination, by using the first image data and the second image data as in the determination of the second embodiment, the determination unit 3004 determines whether the commodity of which the commodity code is read by the scanner 40 is the same as the commodity of which the discount information is read. The control unit 300 causes the determination unit 3004 to determine whether the commodity in the first image data is the same as the commodity in the second image data (ACT 32).

If the determination unit 3004 determines that the commodities are the same (Yes in ACT 32), the registration unit 3005 executes the commodity registration (ACT 9). Next, the control unit 300 determines whether the checkout instruction is input to the input unit 3001 (ACT 10). If the checkout instruction is not input (No in ACT 10), the control unit 300 returns to the process of ACT 1 and waits until the next commodity code is input. If the checkout instruction is input (Yes in ACT 10), the output unit 3007 outputs the transaction information of each transaction stored in the transaction information storage unit 304 to the checkout apparatus 2 (ACT 11). After the output unit 3007 outputs the transaction information, the control unit 300 deletes the transaction information of each transaction stored in the transaction information storage unit 304 (ACT 12), and ends the registration process.

If the flag information is not input in the process of ACT 2 (No in ACT 2), the control unit 300 proceeds to the process of ACT 9. If the discount information is not input to the input unit 3001 in the process of ACT 4 (No in ACT 4), the control unit 300 determines whether a predetermined period of time is elapsed from the input of the commodity code to the input unit 3001 (ACT 13). If the predetermined period of time is not elapsed (No in ACT 13), the control unit 300 returns to the process of ACT 3. If the predetermined period of time is elapsed (Yes in ACT 13), the notification unit 3006 causes the display 31 to display an error message (ACT 14). The displayed error message is a message prompting the customer C to execute the commodity registration again, for example, “The discount information cannot be read. Please execute the commodity registration again”. Next, the control unit 300 proceeds to the process of ACT 10.

If the determination unit 3004 determines that the commodities are not the same in the process of ACT 32 (No in ACT 32), the extraction unit 3003 extracts the feature data that is the identification data corresponding to the commodity code input to the input unit 3001 with reference to the commodity master 312 (ACT 6). Next, the determination unit 3004 executes a second determination (ACT 33). In the second determination, by using the image data (the second image data) obtained if the discount information is read and the feature data of the commodity image stored in the commodity master 312 as in the determination of the first embodiment, the determination unit 3004 determines whether the commodity of which the commodity code is read by the scanner 40 is the same as the commodity of which the discount information is read is determined.

If the determination unit 3004 determines that the commodity of which the commodity code is read is not the same as the commodity of which the discount information is read in the first determination, the reason why the determination unit 3004 executes the second determination is as follows.

As described in the second embodiment, the determination method using the first determination is advantageous in that whether the commodity of which the commodity code is read is the same as the commodity of which the discount information is read can be determined on a per item basis. Here, in order to execute the determination on a per item basis, the barcode BC and the discount seal Y need to be attached to the commodity close to each other. Specifically, as illustrated in FIG. 9, the barcode BC and the discount seal Y need to be close to each other such that at least a part of the discount seal Y obtained by positioning the barcode BC in the reading area B to read the commodity code is positioned in the imaging area A. Therefore, it cannot be said that the configuration is suitable for a commodity where the barcode BC is attached to a back surface. It is desirable that the discount seal Y is attached to a front surface of a commodity such that the customer C can easily recognize the discount seal Y. As a result, the barcode BC and the discount seal Y are attached to the commodity distant from each other.

On the other hand, as described in the first embodiment, the determination method using the second determination is advantageous in that, even when the barcode BC and the discount seal Y of a commodity are attached to positions distant from each other, whether the commodity of which the barcode BC is read is the same as the commodity of which the discount seal Y is read can be determined.

Therefore, in the third embodiment, by executing the second determination if the determination unit 3004 determines that the commodity of which the commodity code is read is not the same as the commodity of which the discount information is read in the first determination, the determination can be executed on a per item basis without any restriction on the position relationship between the barcode BC and the discount seal Y. In other words, by executing the second determination after the determination unit 3004 determines that the commodity of which the commodity code is read is not the same as the commodity of which the discount information is read in the first determination, the advantage of the first embodiment and the advantage of the second embodiment can be obtained.

As a result of the second determination, the control unit 300 determine whether the commodity in the second image data is the same as the commodity identified by the commodity code input to the input unit 3001 (ACT 34). If the control unit 300 determines that the commodities are the same in the second determination (Yes in ACT 34), the control unit 300 proceeds to the process of ACT 9. If the control unit 300 determines that the commodities are not the same in the second determination (No in ACT 34), the control unit 300 proceeds to the process of ACT 14.

In the third embodiment, as in the first embodiment and the second embodiment, even when the registration apparatus 20 is a registration apparatus where the commodity registration is executed by the customer C, fraud by the customer C relating to the discount sale can be prevented.

In the third embodiment, whether the commodity of which the commodity code is read is the same as the commodity of which the discount information is read can be determined on a per item basis, and there is no restriction on the position relationship between the barcode BC and the discount seal Y attached to the commodity.

As described above, the registration apparatus according to the embodiment includes: a reading unit configured to read commodity identification information for identifying a commodity from a code symbol attached to the commodity and to read benefit information regarding a benefit of a commodity from a benefit symbol attached to the commodity; an imaging unit configured to image an imaging area including a readable area of the reading unit; an extraction unit configured to extract identification data corresponding to the commodity identification information read by the reading unit from a memory unit where the commodity identification information and the identification data are correlated with each other, the identification data relating to a commodity image; an acquisition unit configured to acquire image data obtained by the imaging unit if the benefit information is read by the reading unit; a determination unit configured to determine, based on the identification data extracted by the extraction unit, whether a commodity in the image data acquired by the acquisition unit is the same as a commodity that is identified by the commodity identification information read by the reading unit; and a registration unit configured to register, if the determination unit determines that the commodities are the same, transaction information regarding transaction of the commodity identified by the commodity identification information based on the commodity identification information and the benefit information read by the reading unit.

As a result, even when the registration apparatus is operated by the customer C, fraud by the customer C relating to the discount sale can be prevented. There is no restriction on the position relationship between the barcode BC and the discount seal Y attached to the commodity.

The registration apparatus according to the exemplary embodiment includes: a reading unit configured to read commodity identification information for identifying a commodity from a code symbol attached to the commodity and to read benefit information regarding a benefit of a commodity from a benefit symbol attached to the commodity; an imaging unit configured to image an imaging area including a readable area of the reading unit; an acquisition unit configured to acquire first image data obtained by the imaging unit if the commodity identification information is read by the reading unit and to acquire second image data obtained by the imaging unit if the benefit information is read by the reading unit; a determination unit configured to determine whether a commodity in the first image data is the same as a commodity in the second image data; and a registration unit configured to register, if the determination unit determines that the commodities are the same, transaction information regarding transaction of the commodity identified by the commodity identification information based on the commodity identification information and the benefit information read by the reading unit.

As a result, even when the registration apparatus is operated by the customer C, fraud by the customer C relating to the discount sale can be prevented.

In the registration apparatus according to the embodiment, if an image area that is the same as an image area including a code symbol and a benefit symbol in the first image data is included in the second image data, the determination unit determines that the commodity in the first image data is the same as the commodity in the second image data.

As a result, whether the commodity of which the commodity code is read is the same as the commodity of which the discount information is read can be determined on a per item basis, and fraud by the customer C can be further prevented.

In the registration apparatus according to the embodiment, in which the reading unit reads flag information representing that a label representing benefit information is attached to a commodity, and if the benefit information is not read by the reading unit even after a predetermined period of time is elapsed from the reading of the flag information by the reading unit, the registration unit does not register the transaction information of the commodity identified by the commodity identification information.

As a result, fraud by the customer C can be further prevented.

In the embodiment, the control program implemented by each of the tablet terminal 30, the scanner 40, and the store server 3 may be provided after being recorded in a computer-readable recording medium such as CD-ROM. The control program that is executed in each of the apparatuses according to the embodiment may be provided by storing the control programs in a computer connected to a network such as the Internet and downloading the control programs through the network, or may be provided or distributed through a network such as the Internet.

While certain exemplary embodiments have been described, the embodiments have been presented by way of example only, and are not intended to limit the scope of the inventions. For example, in each of the exemplary embodiments, the registration apparatus 20 is configured with the tablet terminal 30 and the scanner 40. By installing an application program for commodity registration in a smartphone having a camera function, the smartphone can also be used as the registration apparatus. Some or all of the processes that are executed by the tablet terminal 30 based on the information read by the scanner 40 may be implemented by a cloud server or the like. In each of the exemplary embodiments, the flag seal Z is used in order to prompt the customer C to read the discount seal Y again. However, the flag seal Z does not need to be used. A camera can also be provided separately from the scanner 40 such that the camera functions as the imaging unit.

Indeed, the exemplary embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A registration apparatus comprising:
a reader configured to read commodity identification information for identifying a commodity from a code symbol attached to the commodity and to read benefit information regarding a benefit of a commodity from a benefit symbol attached to the commodity;
an imaging device configured to image an imaging area including a readable area of the reader; and
a processor configured to
extract identification data corresponding to the commodity identification information read by the reader from a memory configured to store the commodity identification information where the commodity identification information and the identification data are correlated with each other, the identification data relating to a commodity image,
acquire image data obtained by the imaging device in response to reading the benefit information by the reader,
determine, based on the extracted identification data, whether a commodity in the acquired image data is the same as the commodity that is identified by the commodity identification information read by the reader, and
register, in response to determining that the commodities are the same, transaction information regarding transaction of the commodity identified by the commodity identification information based on the commodity identification information and the benefit information read by the reader.

2. A registration apparatus comprising:
a reader configured to read commodity identification information for identifying a commodity from a code symbol attached to the commodity and to read benefit information regarding a benefit of a commodity from a benefit symbol attached to the commodity;
an imaging device configured to image an imaging area including a readable area of the reader; and
a processor configured to
acquire first image data obtained by the imaging device in response to reading the commodity identification information by the reader, and acquire second image data obtained by the imaging device in response to reading the benefit information by the reader,
determine whether a commodity in the first image data is the same as a commodity in the second image data, and
register, in response to determining that the commodities are the same, transaction information regarding transaction of the commodity identified by the commodity identification information based on the commodity identification information and the benefit information read by the reader.

3. The apparatus according to claim 2, wherein
the processor determines that the commodity in the first image data is the same as the commodity in the second image data in response to determining that an image area is included in the second image data that is the same as an image area including a code symbol and a benefit symbol in the first image data.

4. The apparatus according to claim 1, wherein
the reader is configured to read flag information indicating that a label representing benefit information is attached to a commodity, and
the processor is further configured to, in response to not reading the benefit information by the reader even after a predetermined period of time is elapsed from the reading of the flag information by the reader, not read the transaction information of the commodity identified by the commodity identification information.

5. The apparatus according to claim 4, wherein
the reader reads flag information by detecting a flag seal attached to the commodity,
the reader detects the flag seal from a predetermined shape in the image data obtained by the imaging device.

6. The apparatus according to claim 1, wherein the memory includes a non-transitory computer readable medium configured to store instructions, which, when executed by the processor, cause operations to be carried out, the operations comprising
registering the commodity, and
determining whether the discount information read by the reader is appropriate based on the image data obtained by the imaging device.

7. An information processing apparatus comprising a processor configured to:
receive, as an input, commodity identification information for identifying a commodity and benefit information regarding a benefit of the commodity from a reader that reads the commodity identification information and the benefit information;
extract identification data relating to a commodity image and corresponding to the received commodity identification information from a memory configured to store the identification data and correlate the commodity identification information and the identification data,
acquire first image data obtained in response to reading the commodity identification information by the reader, and acquire second image data obtained in response to reading the benefit information by the reader, the first image data and the second image data relating to an imaging area including a readable area of the reader;
determine, based on the extracted identification data, whether a commodity in the first image data is the same as a commodity in the second image data, and
register, in response to determining that the commodities are the same, transaction information regarding a transaction of the commodity identified by the commodity identification information based on the commodity identification information and the benefit information received as the input.

8. The apparatus according to claim 7, wherein the processor is further configured to output, in response to determining that the commodities are not the same, a notification to repeat a commodity registration.
